(19) United States
(12) Patent Application Publication
(10) Pub. No.: US 2017/0159618 A1
(43) Pub. Date: Jun. 8, 2017

(54) Hydrogen on Demand Electrolysis Fuel Cell System

(71) Applicant: NRG Logistics, LLC, Hinsdale, IL (US)

(72) Inventors: David Todd Forbes, Hinsdale, IL (US); Jeremy Green, Cocoa, FL (US); Chris Kruckenberg, Newburgh, IN (US)

(21) Appl. No.: 15/441,355

(22) Filed: Feb. 24, 2017

Related U.S. Application Data
(63) Continuation of application No. 14/212,631, filed on Mar. 14, 2014, now abandoned.
(60) Provisional application No. 61/787,465, filed on Mar. 15, 2013.

(51) Int. Cl. F02M 25/12; B01D 46/00; F02B 43/10; C25B 1/08

(52) U.S. Cl. CPC F02M 25/12; C25B 1/08; B01D 46/0027; F02B 43/10; B01D 2279/60; F02B 2043/106

(57) ABSTRACT

A hydrogen and oxygen (HHO) gas on-demand electrolysis fuel cell system for use with internal combustion engines is disclosed. This hydrogen on-demand (HOD) system integrates with the engine control module (ECM) or other control system that regulates the operation of an internal combustion engine in order to supply HHO to the engine and improve the engine's overall fuel efficiency. This system includes an electrolyte fluid reservoir outfitted with level, pressure and temperature sensors; a pump and heat exchanger; a uniquely-configured electrolyzer; and a filter. The combined engine and HOD system is controlled and regulated by an electronic control system (ECS) and a combustion control module (CCM). The CCM is installed on the engine such that it actively intercepts the electronic signals from the engine manufacturer's ECM to continuously coordinate the functions and operations of the HOD system and the engine.

### FIELD OF THE INVENTION

This specification generally describes an electrolysis fuel cell system that is designed to produce hydrogen and oxygen (HHO) gas on-demand and to supply these gasses into the combustion chambers of internal combustion engines. More specifically, this specification describes a new configuration of a hydrogen on-demand (HOD) system that integrates with the engine control module (ECM) or other control system that regulates the operation of an internal combustion engine in order to supply HHO to the engine and improve the engine's overall fuel efficiency. This system is further designed to produce a continuous flow of HHO produced via electrolysis from an aqueous fluid, which is then mixed with the engine's air supply. This system facilitates these functions by providing an integrated system comprising an insulated electrolyte fluid reservoir outfitted with level, pressure and temperature sensors; a pump and heat exchanger; a uniquely-configured electrolyzer; and a filter. The combined engine and HOD system is controlled and regulated by an electronic control system (ECS) and a combustion control module (CCM). The CCM is installed on the engine such that it actively intercepts the electronic signals from the engine manufacturer's ECM to continuously coordinate the functions and operations of the HOD system and the engine.

### BACKGROUND AND SUMMARY OF THE INVENTION

Hydrogen is the most abundant element in the universe. Atomic and molecular hydrogen have significant potential as an energy source due to hydrogen's high combustibility, yet naturally-occurring atomic hydrogen gas is rare because hydrogen readily forms covalent compounds with non-metallic elements. Hydrogen is also present in most organic compounds and in water. Power production engineers have for many years sought mechanisms to harness the energy potential of hydrogen, but thus far those efforts have barely scraped the surface of that potential. One significant detriment that is prevalent in many or most prior art systems is that the energy and resources required to produce a sufficient quantity of hydrogen with those systems typically outstrips the energy that is then recoverable from the hydrogen that is so produced.

Most industrial production of hydrogen gas is the result of a by-product of hydrocarbon fuel refining. Hydrogen can also be produced by the more energy-intensive process of electrolyzing water, in which a cathode and an anode are submerged into an aqueous solution and an electrical current is passed across them. As noted, this process is energy-intensive and inefficient to the extent that more energy may be required to produce hydrogen gas than may ultimately be recovered from that gas. This process breaks the bonds in water molecules, resulting in the production of hydrogen and oxygen gases with a 2:1 molar ratio of diatomic H₂ and O₂ gases, which is the same proportion as water. Given the energy potential of hydrogen, it is well known in the art that adding HHO into the air stream of an internal combustion engine will substantially increase the efficiency of that engine. It is theoretically possible to produce HHO separately, to store gaseous hydrogen and/or oxygen under compression in a storage tank, and then to supply those gases to the air stream that is powering the internal combustion engine in order to gain this efficiency. However, it is altogether impractical to implement this manner of a storage system due to the weight and bulk of the gas storage system that would be required.

The hydrolysis process that forms diatomic H₂ and O₂ gases is well known and understood in the art. Specifically, when a cathode and anode are submerged in pure water, a reduction reaction occurs at the negatively-charged anode, causing electrons (e⁻) from the cathode to be given to hydrogen cations to form hydrogen gas. At the positively-charged anode, an oxidation reaction occurs, which generates oxygen gas and provides electrons to the cathode, thus completing the circuit. When the reduction and oxidation reactions are combined and balanced, the overall reaction is such that for every two molecules of aqueous water, 2 molecules of diatomic gaseous hydrogen (H₂) and one molecule of diatomic gaseous oxygen (O₂) are formed. The number of diatomic hydrogen molecules that are formed is thus twice the number of diatomic oxygen molecules. Under the proper conditions, the amount of energy that is required to produce diatomic H₂ and O₂ gases will at least be matched by the efficiency improvements achievable via adding those gases to the combustion processes in an internal combustion engine.

Accordingly, and as is demonstrated by the prior art, many attempts have been made to design and implement an electrolysis system that produces HHO gas in an on-demand manner from a stored aqueous solution and then to supply that gas to internal combustion engines. Most if not all of those attempts, however, have proved to be inadequate, inefficient, or unsafe. Some of the problems experienced with those systems include, for example, production of inadequate amounts of HHO gas; corrosion and rapid decay of the electrolyzers; and potential safety problems due to buildup of excess HHO without safety or shut-down controls, presenting an environment in which explosive combustion occurs away from the internal combustion engine. Further, it is well-recognized that the energy required to split water molecules into their gaseous components generally exceeds the energy that is recouped when the component gases are burned. Thus the challenge that has yet to be met is how to produce adequate amounts of HHO gas with an on-demand system that is safe, stable and corrosion resistant such that the HHO gas improves overall efficiency.

A need therefore exists for a HOD production system that can be integrated into a new or existing internal combustion engine or other energy production means to provide the greatest improvement in the efficiency of that engine. This system will account for, address, and solve the many problems presented by prior art systems. It will further take advantage of and optimize HHO production via the electrochemical reaction that produces hydrogen and oxygen gas, and will do so in a continuous manner to maintain an adequate and consistent flow of HHO gas into the air stream that supplies the engine while integrating the control and operation of the electrolysis systems into the fundamental control and operation of the internal combustion engine itself. Moreover, the system must integrate seamlessly with the engine manufacturers' computerized engine control modules (ECM's) that adjust air and fuel flow into engines.

There is also a need for a novel HOD electrolysis system for use with internal combustion engines that are powered by fossil fuels. This system may be incorporated directly into the operational designs for a new engine, or it may be retro-fitted into existing engines. It is desirable that such a system also work with diesel, gasoline, natural gas or other alternative-fuel combustion engines.

There is further need for a system that utilizes the existing electrical power supply that produces electrical power for an internal combustion engine to power the electrolysis cells. The system also includes a novel combustion control system that interfaces directly with the engine control module that controls and regulates the operation of the internal combustion engine.

Still further, there is a need for components that make up a novel HOD system for use with internal combustion engines, as well as a method for implementing and utilizing that system and its components. Other methods described in this specification include a method of utilizing a novel HOD system to improve a vehicle's fuel economy; a method for lowering a vehicle's emissions by providing a cleaner-burning air and fuel mixture into the combustion chamber, which mixture is generated with a novel HOD system; a method of increasing the power that is delivered to a vehicle's drive train through an improved combustion system, which improvement is provided by a novel HOD system; and a method of filtering the HHO production from an on-board vehicle electrolysis system that minimizes or eliminates the potential flow of fluid into an engine's air supply. These and other features of the present electrolysis fuel cell system will become apparent to persons skilled in the arts upon reviewing this specification.

### DESCRIPTION OF THE DRAWINGS

FIG. 1 is a schematic flow chart that illustrates the components of one embodiment of an electrolysis fuel cell system and the fluid flow between and among those components.

FIG. 2 is another embodiment schematic flow chart that illustrates the components of one embodiment of an electrolysis fuel cell system and the electrical connections between and among those components.

FIG. 3A is an overall perspective view of one variant of a fluid reservoir and filter that may be utilized with one embodiment of an electrolysis fuel cell system. FIG. 3B is a side view of the fluid reservoir and filter. FIG. 3C is a top-down view of the fluid reservoir and filter. FIG. 3D is a cut-away view of the fluid reservoir and filter, showing the internal configuration of the reservoir and the internal components of the filter.

FIG. 4 is another cutaway view of a filter assembly that may be used with one embodiment of an electrolysis fuel cell system.

FIG. 5A is an expanded view of a hydrolyzer assembly that may be used with one embodiment of an electrolysis fuel cell system, and FIG. 5B is a side perspective view of that hydrolyzer assembly when it is fully assembled.

FIG. 6 is an overall perspective view of an embodiment of a completely assembled hydrolysis-on-demand system configured according to this specification and ready for installation on the chassis of a vehicle that is powered by a diesel internal combustion engine.

### DETAILED DESCRIPTION OF THE INVENTION

### Schematic

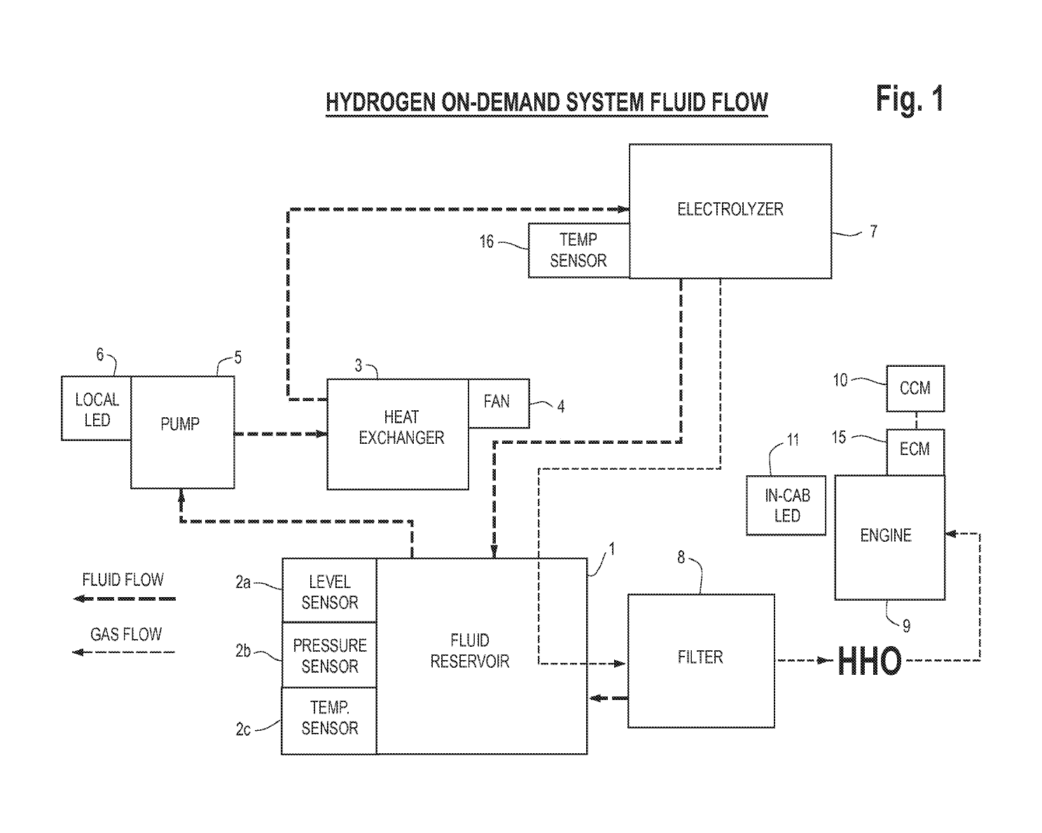

A schematic flow chart showing the components of an embodiment of an HOD system is depicted in FIG. 1. As shown therein, this system includes a fluid tank or reservoir 1 that includes at least integrated sensors 2a, 2b, and 2c to detect, for example, fluid level and both the gaseous pressure and temperature of the fluid within the reservoir. Those of skill in the art will recognize that additional or different sensors may be included. A pump 5 controls the flow of fluid from the reservoir to a heat exchanger 3 and into an electrolyzer 7. The heat exchanger 3 is utilized to adjust the temperature of an electrolyte fluid that is stored in the reservoir 1 and pumped through the system into the electrolyzer 7. The heat exchanger 3 preferably also includes an integrated fan 4 that passes air over the heat exchanger to cool the electrolyte fluid and to dissipate any excess heat generated within the heat exchanger. Light-emitting diodes (LED's) 6 or other visual indicators may be utilized locally to show the operating status of the system. HHO gases, as well as electrolyte fluid and other byproducts pass from the electrolyzer 7 to the reservoir 1, and then into the filter 8, which separates the desired HHO gases from other components. The HHO gases are then supplied into the air stream that is used to power the engine 9. A Combustion Control Module (CCM) 10 includes computerized coding and controls to intercept electronic signals sent to the engine's ECM, including for example, engine oil pressure and engine RPM's. The CCM coordinates these signals with the operations of the HOD system to facilitate fully-integrated and continuous operations of the combined engine and HOD system. The system may also include one or more visual indicators, such as LED's 11 that are installed on the dashboard or at some other location where an operator of the engine can readily observe them. The LED's 11 inform the operator that the system is in operation and whether and to what extent the system is functioning in accordance with its specifications. The functions and operation of the entire system are monitored and controlled by an Electronic Control System (ECS) 12, which interfaces with the CCM 10 in a “handshake” mode to confirm that the operations of the engine and the HOD system are synchronized. The system itself is powered by a direct current power source, such as battery 13 that also provides direct current power to other electrical systems that operate in conjunction with the engine.

In standard operation, the charge of battery 13 is sustained by an alternator 14 that is installed with the engine 9. In typical operation without an HOD system, a tractor-trailer truck will draw between 40 and 50 amps to power lights and other electrical equipment. Under ideal operating conditions, an embodiment of an HOD system described herein will draw 10 amps to generate one liter of HHO gas per minute. At a preferred generation rate of 6 liters of HHO gas per minute, under ideal conditions the system will draw 60 amps. Under actual (i.e. non-ideal) conditions, with a truck engine idling at between 800 and 1,000 RPM, the embodiment of an HOD system described herein will produce, on average, six liters of HHO gas per minute and will consume between 75 and 100 amps. A standard truck engine alternator will generate only approximately 50-60 amps at idle. Therefore, in a preferred embodiment of the system in real-time operation, the operator replaces the standard truck engine alternator with a greater capacity alternator. Commercially-available after-market alternators that produce approximately 150 amps at idle are suitable for this purpose. Although the higher-capacity alternator generates higher resistance and requires more engine power to generate a higher amperage, this increase is offset by the overall increase in efficiency resulting from the controlled infusion of HHO gas into the engine's combustion cycles.

Prior art hydrogen on demand (HOD) and hydrolysis systems generally include some combination of some or all of the components shown in FIG. 1. The present HOD system represents an advance over prior art systems in that its components are specifically engineered and designed to work in conjunction with each other and with an internal combustion engine in real-time during normal operations. In particular, the embodiment of the HOD system described herein operates in coordinated control with the electronic engine control module (ECM) that manages the air and fuel flow and the combustion cycles of the engine to which the hydrolyzer is attached. This coordinated control improves the overall efficiency of the combined HOD system and engine.

The hydrolysis process of an embodiment of an electrolysis fuel cell system starts with the electrolytic fluid that is used to supply HHO gas. In practice, pure water may be used as an electrolytic fluid in any electrolysis system. Electrolysis of pure water, however, requires an excess amount of energy in order to overcome the tendency of water to self-ionize, i.e. to break into ionic components H⁺ and OH⁻. This self-ionization defeats the desired breakdown of water into its component gases H₂ and O₂ in their diatomic states. To overcome this tendency and to increase the efficiency of the electrolysis process, electrolytes are added to water and an electrolytic solution is preferred for HOD systems like the one described herein.

This HOD system will work with any standard electrolytes in an aqueous solution, including one or more of Potassium, Cesium, Sodium and Magnesium, all of which will be in cation form i.e. K⁺, Cs⁺, Na⁺ or Mg⁺. One important parameter for selection of an electrolyte in electrolysis systems is for the electrolyte to have a lower electrode potential than that of hydrogen, H⁺. The problem created by addition of an electrolyte, however, is that the electrolytic solution then is more caustic, leading to potential decay and corrosion of major components of an HOD system. A preferred embodiment of the present HOD system utilizes potassium hydroxide (KOH) electrolytic fluid, which is a strong base (i.e. high pH) and is caustic. The caustic nature of this electrolyte requires that the manufacturer select the proper materials for construction of any and all components of the HOD system that are in contact with the electrolyte fluid. Those materials must also be compatible with each other to avoid, for example corrosion or degradation caused by reduction/oxidation reactions where two different types of metals are in contact. Persons skilled in the art of handling and transporting caustic base materials will be able to select appropriate materials that are compatible with high pH electrolyte fluid in order to meet these criteria.

The concentration of the electrolyte solution will be determined by parameters such as the desired efficiency of the HOD process, the one or more chosen electrolytes, and the ambient conditions in which the system will be utilized. Where KOH is the selected electrolyte solution, concentrations of as low as 2% may be adequate for efficient operation. Yet many engines are used in extreme high- or low-temperature conditions. In very low-temperature conditions, a 2% KOH solution would freeze. Increasing the KOH concentration into a range of 20% to 30% helps to prevent the electrolyte solution from freezing in extremely low temperatures. For example, at a concentration of approximately 30%, a KOH solution remains in a liquid state at temperatures as low as −65° F. (−54° C.). At concentrations above 30%, KOH solutions begin to lose this antifreeze characteristic. Accordingly, the manufacturer or operator of this system determines the optimum concentration of the electrolyte solution for the ambient temperatures in which the system will be utilized.

### The Fluid Reservoir and Filter

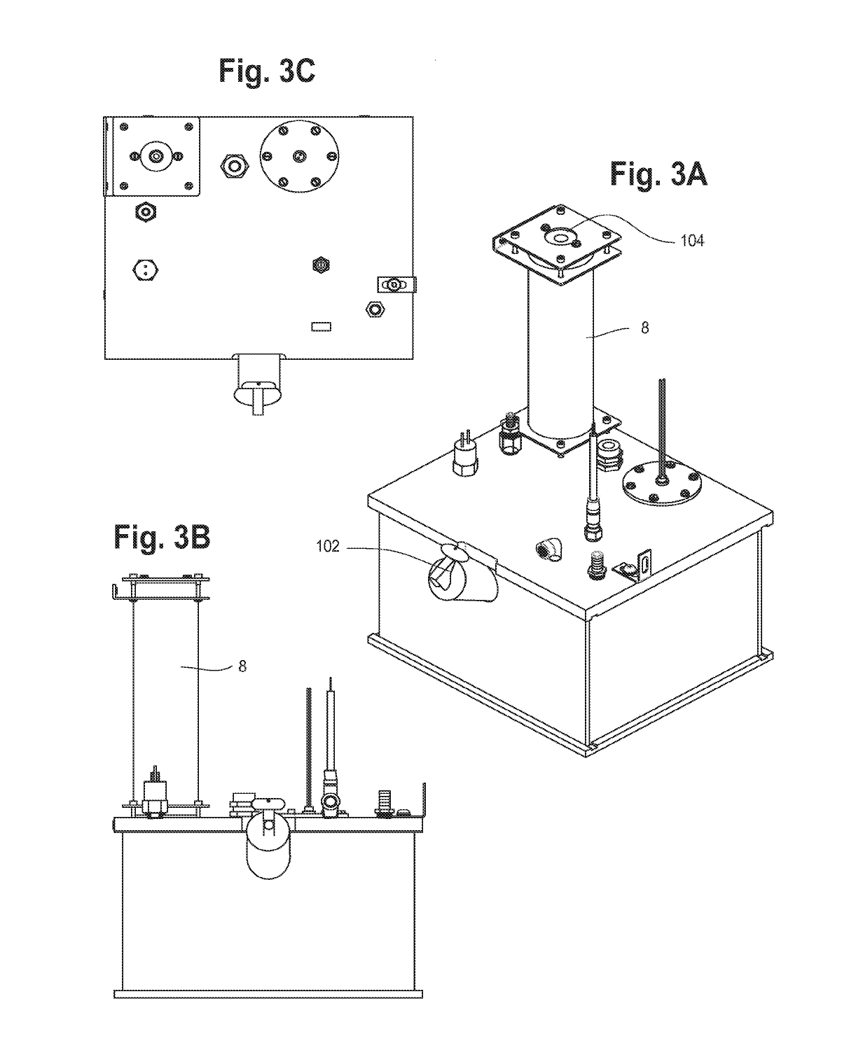

The first component in the embodiment of the present HOD system is a fluid reservoir 1 and filter 8. Electrolytic fluid is pumped into and stored in a fluid reservoir, shown as reservoir 1 in FIG. 1. The reservoir 1 is selected to provide a stable support system for fluid levels and includes temperature and pressure sensors 2 that are integrated into the tank. Prior art HOD systems pay little or no attention to the electrolyte fluid reservoir, and instead describe only generic electrolyte storage tanks that ultimately work at odds with the hydrolysis system. As shown in greater detail in FIGS. 3A and 3D, the reservoir 1 of the present system is designed with an overfilling prevention safeguard such as a fluid fill tube 100 that facilitates filling the reservoir without risk of overfilling. The fill tube 100 includes a receiving end 101 that is closed off and sealed by reservoir plug 102. Plugs 102 that are appropriate for this purpose are known to practitioners skilled in the arts of this invention. The plug 102 preferably includes a mechanism that precludes its loosening due to vibrations or other physical forces, and that prevents unwanted substances from entering and contaminating the fluid reservoir 1.

The fill tube 100 is canted downward into the reservoir 1 from its receiving end 101 and terminates at end 103, which is permanently fixed near the lower portion of the internal body of reservoir 1. This configuration helps to eliminate the prospect of overfilling of reservoir 1, which, if overfilled, may lead to electrolyte fluid being infused into the internal combustion engine's air intake. In its preferred embodiment, this reservoir 1 includes an integrated flush and fill system to facilitate emptying and filling of the reservoir with fluids that may require special handling considerations. It is preferably configured to maintain a minimum air space between the electrolytic fluid and the inside top of reservoir 1. Further in its preferred embodiment, a fluid return tube that originates at the electrolyzer 7 terminates in the reservoir 1 in a manner that facilitates reintroduction of HHO gas, along with electrolyte fluid, back into the aqueous solution. Because the overall system includes the fluid return tube to return electrolytic fluid from the filter 8 back into the reservoir 1, the reservoir includes piping connecting the reservoir and the base of the filter. Lastly, the reservoir 1 may be configured to be rigidly and firmly attached to the cabinet of the system and then attached to a chassis or to some other support structure that allows an HHO hose to port HHO gas to the internal combustion engine.

In an embodiment of the HOD system, the reservoir 1 also includes an internal pressure sensor switch and a pressure safety relief valve, as well a temperature and fluid level sensors 2. The signals from this switch, valve, and these sensors 2 may be monitored by ECS 12 (see FIG. 1) such that in the event that internal gas pressure in reservoir 1 exceeds a predetermined threshold value, for example, the hydrolysis reaction is stopped until pressure is reduced or the condition that caused the excess pressure is diagnosed and corrected. Persons skilled in the art will understand the utility of these and other sensors that may be included in reservoir 1 for safety or other operating purposes. In a preferred embodiment, the reservoir 1 is able to contain elevated internal pressures that exceed a designated operating pressure of the HOD system. In operation, the pressure sensors will communicate with the ECS 12 to cause all or a portion of the HOD system to shut down well before a maximum threshold pressure is realized. For example, the electrical operation of the HOD system is shut down if the internal reservoir pressure exceeds a specified elevated upper limit, and its mechanical operations are shut down if the pressure exceeds some other upper limit. Persons skilled in the art will understand the maximum pressure limits that will be appropriate for systems such as the one described in this specification.

As seen in FIGS. 3A, 3B and 3D, filter assembly 8 is rigidly attached to the top surface of reservoir 1. In its preferred embodiment, filter assembly 8 is a multi-stage filter. FIGS. 3A, 3B and 3D show that the filter assembly 8 may be oriented in a perpendicular fashion relative to the top surface of reservoir 1. Perpendicular orientation is not necessary, and the filter may be slanted away from a vertical or perpendicular axis. HHO gas, vapor, residual hydrolytic fluid and byproducts from electrolyzer 7 are directed back into reservoir 1. As the products accumulate in reservoir 1, HHO gases enter the filter assembly 8. Some residual fluid may also seep into the filter assembly 8. The filter assembly 8 separates the HHO gases from residual fluids, and channels the gases into a hose that then supplies these gases into the air stream of the internal combustion engine 9. Residual fluid is returned to the reservoir 1 via a gravity feed. Accordingly, relatively purer HHO gases that are not contaminated with residual fluid are allowed to enter the air stream of the engine 9.

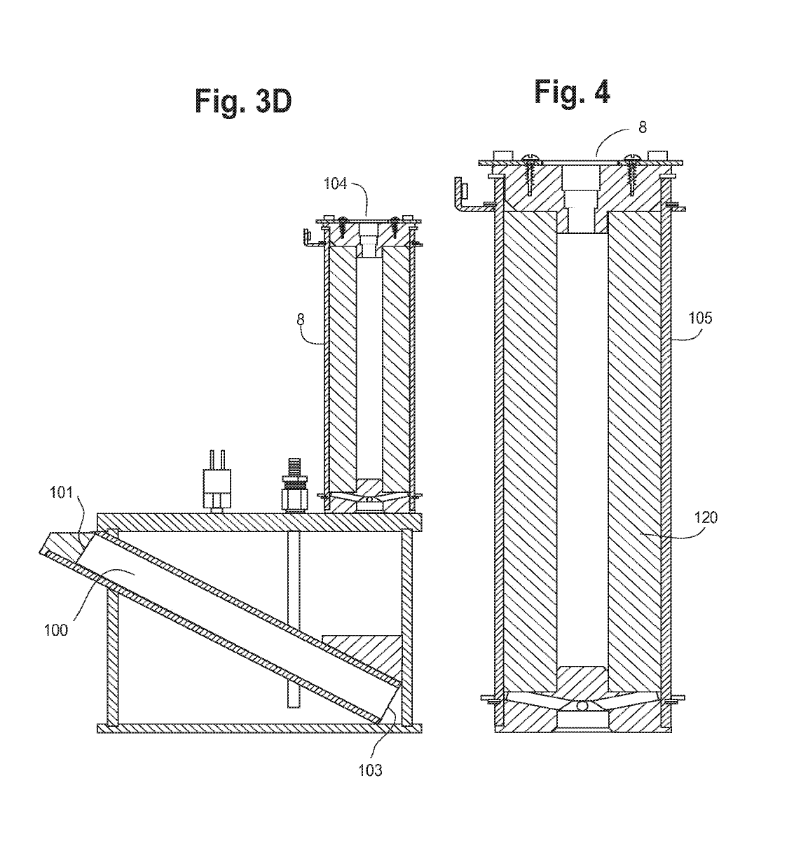

As shown in greater detail in FIG. 4, filter assembly 8 comprises a filter housing 105 and filter cartridge 120 that is centrally oriented in housing 105. In a preferred embodiment shown in FIG. 4, after the HHO gases are fed into filter assembly 8, purer HHO gases leave the filter and are fed into the engine 9, and residual fluid collects at the bottom of filter assembly 8 and is fed back into reservoir 1. More generally, the filter assembly 8 is comprised of top and bottom caps, a filter tube body, and filter media that includes the filter cartridge. The bottom cap is configured to supply HHO gases that are produced in the electrolyzer 7 into the space between the exterior of filter cartridge 120 and the interior of the filter assembly wall. HHO gases pass through filter cartridge 120 into the center of the filter assembly, and residual fluid drains back into the reservoir 1. The HHO gases are then fed into the engine 9. The bottom and top caps of the filter assembly have protrusions or other means to securely hold the filter media in place within the assembly 8.

The filter cartridge 120 is assembled prior to insertion within the body of filter assembly 8. An operator can easily replace this filter cartridge after it has served its useful life.

### The Pump and Heat Exchanger

The second component of an embodiment of the electrolysis fuel cell system described in this specification is the pump 5 that controls the fluid flow throughout the system. In a preferred embodiment, the pump includes a brushless motor and inflow and outflow fittings, and, like reservoir 1, is produced from materials that can withstand a caustic environment created by the electrolytic solution.

The third major component of one embodiment of an electrolysis fuel cell system described in this specification is the heat exchanger 3. The electrolysis process is most efficient when the electrolytic fluid is maintained within a desired temperature range. The desired temperature range is −40° F. to 200° F., more preferably 0° F. to 120° F., even more preferably at 40° F. to 100° F. For example, at extreme low-temperature conditions, relatively higher concentrations of KOH electrolytic fluid (e.g, 20-30%) will not freeze, but the fluid is at too low a temperature for efficient electrolysis. In an embodiment of the HOD system design for low-temperature use, the reservoir 1 is encased in a thermal heating blanket or jacket to raise and maintain the fluid temperature within the desired range. An automotive grade heat exchanger 3 is then used to maintain the electrolyte fluid in the desired temperature range. Where the ambient temperature may be too high for efficient electrolysis, an automotive-grade cooling fan 4 is utilized to maintain the desired fluid temperature range.

### The Electrolyzer

The fourth component of one embodiment of an electrolysis fuel cell system described in this specification is electrolyzer 7. Many traditional HOD systems focus on certain configurations of electrolyzers. The design of electrolyzer 7 within the present HOD system is different from all of these traditional systems.

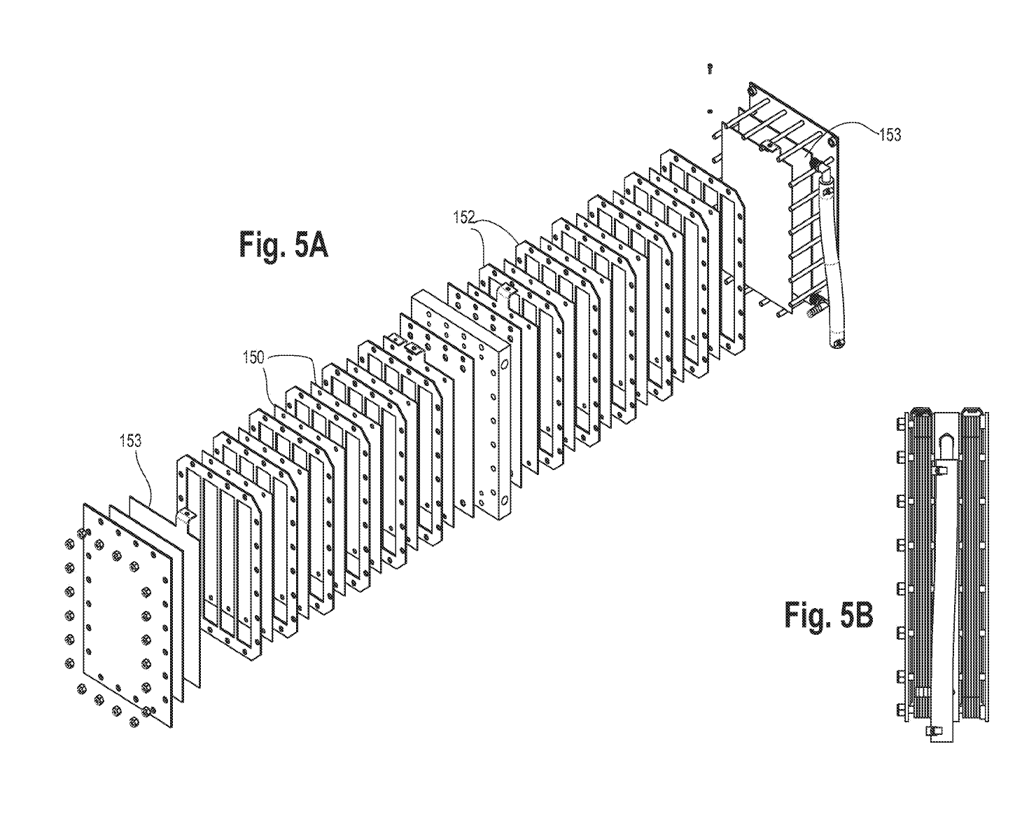

In a preferred embodiment, electrolyzer 7 includes four electrolysis compartments, each of which comprises six vertically-oriented electrolysis chambers on each side of the center manifold. As shown in the expanded view in FIG. 5A, each chamber in this preferred embodiment is formed by five vertically-oriented neutral anodes 150 and six vertically-oriented gaskets 152. This chamber assembly is book-ended by cathodes in the form of charged plates 153, which are constructed of, for example, stainless steel. To minimize electrical destruction and degradation, a non-corrosive material such as high percentage nickel plate can be used for the neutral anode plates 150. It is not the intention of the inventors to limit the invention to these specific materials. Metals or alloys having destruction-resistant properties are appropriate for the purposes described herein.

A side view of a pair of fully-assembled electrolysis compartments is shown in FIG. 5B. A manifold is utilized to evenly and equally distribute the electrolytic fluid that travels from the pump 5 between the four electrolysis compartments. The fluid enters the chambers from supply ports in the manifold, which are aligned at the bottom of the chambers. The ports are aligned with the vertical slots defined by the charged plates 153 and anodes 150. Gaskets 152 maintain chambers in the electrolyzer through which the electrolytic fluid is pumped. A preferred embodiment generates an electrolytic fluid flow of approximately one gallon per minute, divided evenly into the four electrolysis compartments. The present system is at its most efficient when surfaces of the charged plates 153 and anodes 150 are submerged in fluid to the maximum amount possible. In a preferred embodiment, the pump 5 is configured to maintain a fluid level of 75% to 85% of the maximum possible fluid level in the chambers at all times. The fluid flow through the chambers further helps to dislodge HHO gas bubbles from the cathode and anode plates, where they may adhere due to surface tension and other effects. The plurality of plates in the electrolyzer 7 creates a large aggregate charged surface area, thus increasing HHO gas formation.

Corresponding ports at the top and bottom of the manifold are aligned to distribute electrolytic fluid and to collect HHO gases, vapor, fluid and byproducts of the electrolysis reaction. The two corresponding manifold ports also prevent HHO backpressure from affecting the electrolysis operation, which may occur if the fluid level in the chambers is pushed back by that pressure. Further, the exit ports may be configured to include tubing with wider inner diameters to enable a higher volume of gas to exit the electrolyzer compartments. The HHO gas, residual fluid and byproducts then leave the electrolysis section through collection tube 170, which feeds back into the fluid reservoir 1.

Electrolysis of the electrolytic fluid and formation of HHO gases is accomplished at the cathode and anode plates. In one embodiment, a charge of between twelve and fourteen volts, with current in the range of seventy-five to one hundred amps, is applied across the spaces defined by the gasket construction between the cathodes and anodes. The battery 13 that supplies direct current power to other electrical systems is utilized as the source of the voltage and current that is applied across the cathodes and anodes. In a preferred embodiment, the electronics of this HOD system regularly reverse the polarity in electrolyzer 7, thus keeping the cathode and anode plates clean and free from unwanted buildup, reducing or eliminating buildup or corrosion on the plates and thus contamination in the electrolytic fluid. It is not the intention of the inventors to limit the system to an operating environment within the above-described voltages and amperages, and this system may be alternately configured to function in other ranges.

### The Control Systems

The Electronic Control System (ECS) 12 and the Combustion Control Module (CCM) 10 (which interfaces with the engine manufacturer's Electronic Control Module (ECM)) are the fifth component of one embodiment of an electrolysis fuel cell system described in this specification. When the internal combustion engine 9 is turned on, CCM 10 will be encoded to sense an increase in parameters such as engine oil pressure and to measure engine RPM's. CCM 10 then signals ECS 12 utilizing controller area network (CAN) based communication to verify that the engine is running and that combustion of the primary fuel is occurring. Traditional systems generally use sensing mechanisms to determine if an engine is running including, for example sensors that detect oil pressure in the engine once it is turned on. Those systems then commence production of HHO gases. This traditional methodology, however, is imperfect. Modern engines are controlled by the engine manufacturer's ECM, which regulates air and fuel injection into the engine as a function of various operating conditions. Traditional HOD systems that do not interact with a manufacturer's ECM will be less effective and efficient because the ECM will generally not recognize the alternative operating conditions that are caused when an HOD system comes on-line. The CCM 10 that is an integral part of the present HOD system receives appropriate signals from the manufacturer's ECM to confirm engine operation, then sends corrected signals back to the engine as the HOD system comes online. Further, the ECS 12, which regulates the operation of the HOD system itself, and CCM 10 both have built-in programming safeguards such that if the electrolyzer 7 ceases operations, regardless of the reason for such cessation, an alert will be generated and the CCM 10 will instruct the engine to return to non-HHO assisted performance. Also, if the engine 9 ceases operation for any reason, the electrolyzer 7 will stop HHO production. In these manners, this novel and significant CAN-based communication between the ECS 12, CCM 10, and helps to eliminate safety risks.

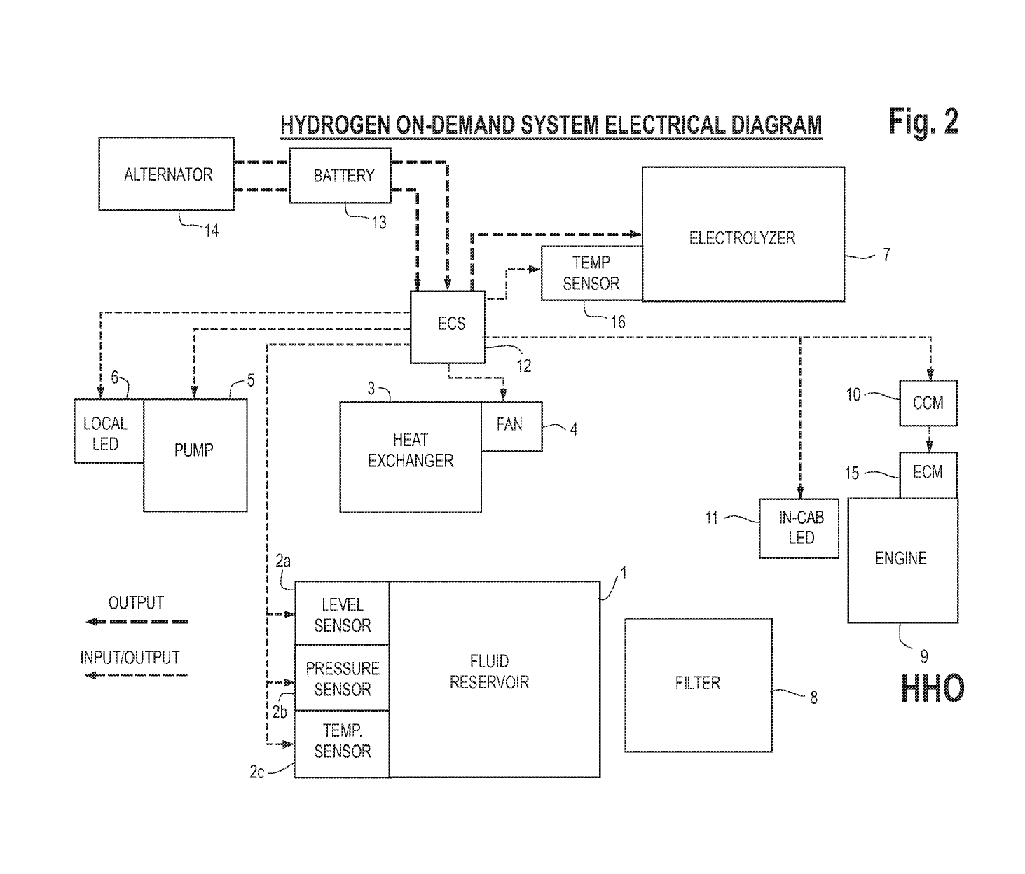

In operation, when ECS 12 receives the signal the engine 9 is running, the embodiment of an electrolysis fuel cell system described in this specification commences its startup protocol in which the fluid level in reservoir 1, the temperatures of the fluid in the reservoir and throughout the system, system air pressure, and the function of pump 5 and fan 4 are confirmed. The electrical signals and flow of information within the system are depicted in FIG. 2. Following completion of the startup protocol, ECS 12 sends a “ready’ signal to CCM 10. After sending the “ready” signal, ECS 12 will initiate electrical power flow to electrolyzer 7, thus beginning the production of HHO gases. The gases thus produced are supplied into the air intake manifold via a gas-delivery hose and a custom venturi device, which delivers the gases into the middle of the air stream. Delivery of the HHO gases in this manner minimizes or prevents the buildup of backpressure within the system.

The ECS 12 then confirms that power has been provided to electrolyzer 7 and that HHO gases are being produced. Once operation of these systems is verified, the CCM 10 commences interactions with any on-board computer that controls engine functions to ensure that HHO gases introduced by this system into the air intake are recognized as a combustible fuel and not as additional air. Internal combustion engines manufactured after 2003 generally include numerous oxygen and other types of sensors. The signals sent by these sensors in the presence of the extra HHO gas produced by the present system, without CCM interaction, could actually cause a decrease in overall engine efficiency. In a preferred embodiment, communication between the engine 9, ECS 12 and CCM 10 is optimized to improve overall performance of the engine and system combination.

The control protocols encoded into ECS 12 and CCM 10 further include a wattage regulation and control component that regulates wattage across the electrolyzer plates while channeling different voltages to other components within the system. The voltage across the overall system is provided by the vehicle's onboard battery, which generates a 12-volt potential. ECS 12 and CCM 10 regulate that voltage such that the higher voltage potential is generated across the cathode and anode plates and a lower voltage potential drives some the other components, which may not require a higher voltage potential.

In practice, the system and its multiple components are constructed to withstand and survive extreme ambient conditions, to absorb regular shock and vibrations which are translated into the system, and to provide continuous operations for hundreds of hours, or other commercially-reasonable stretches of time. An external wire harness is required to integrate CCM 10 and ECS 12. As is seen in FIG. 2, electrical communications are also established between ECS 12 and the level, pressure and temperature sensors 2 in reservoir 1. ECS 12 manages the power being supplied to electrolyzer 7, reads all sensors, manages fault conditions and controls all fluid flow and temperature control throughout the system. The temperature sensors 2 are, for example, standard thermistors that are placed at various points, including in and around reservoir 1 and on electrolyzer 7. ECS 12 preferably includes safety protocols to shut down all or a part of the system if, for example, the temperature sensors indicate that the system is operating outside of the desired temperature range. Temperature sensors may also be included to read ambient temperatures.

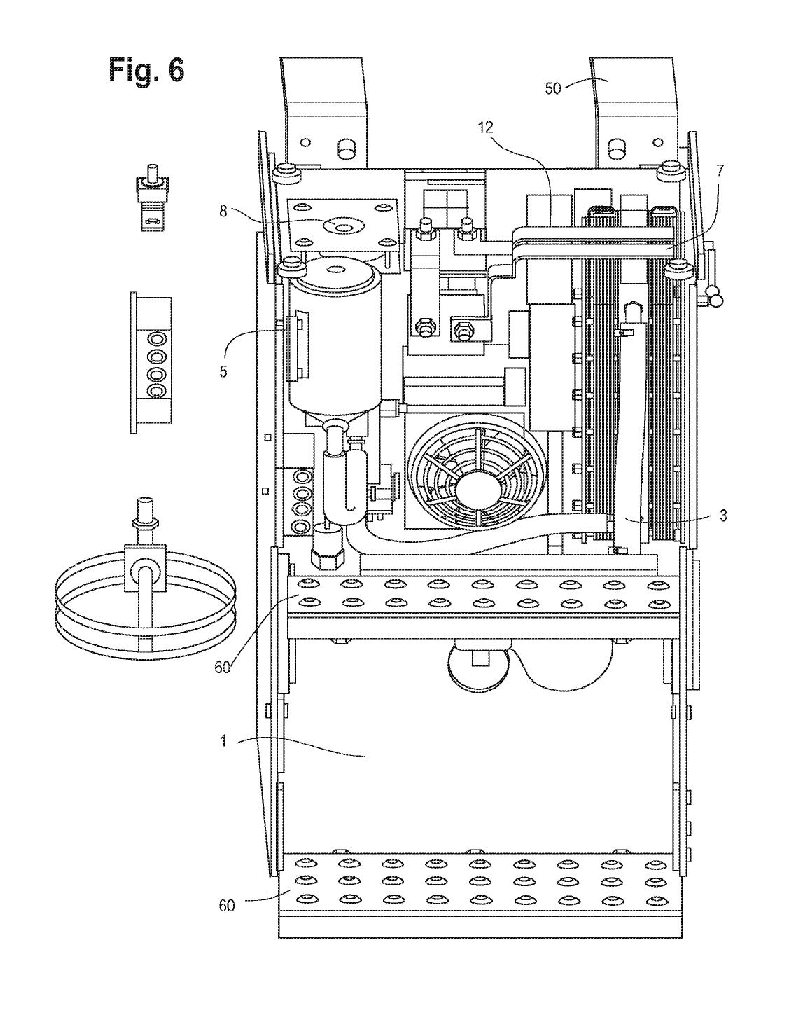

An embodiment of the assembled system is shown in FIG. 6. The system shown in FIG. 6 is designed to be mounted on the frame rail of a semi-tractor. The system may also be configured to be used with other types of internal combustion engines and/or to be mounted on other types of vehicle frames. Fluid reservoir 1 forms the base at the bottom of the entire system. The capacity of reservoir 1 is selected such that the reservoir capacity is sufficient to hold a quantity of electrolytic fluid that will provide HHO gas to a diesel tractor-trailer engine for several thousand miles. Capacities will vary according to the uses to which a vehicle is subjected. The major system components of the system are shown here: reservoir 1 and filter 8; pump 5 and heat exchanger 3; electrolyzer 7; and ECS 12. This entire system is built into an integrated cabinet that may be mounted onto a truck frame via mounting brackets 50. Steps 60 may also be integrated into the system to allow an operator or mechanic to climb onto the frame for maintenance or other purposes.

The foregoing specification thus describes only the preferred embodiments of the present HOD system and the method of producing HHO gas for use by an internal combustion engine. A power production engineer or other persons skilled in the art and familiar with the challenges and opportunities presented by this type of system will appreciate that the breadth and scope of the present invention is not limited to the preferred embodiment described herein, but extends also to both broader and more tailored embodiments. It is the intention of the inventors to include this more expansive scope within the ambit of their invention.

What is claimed is:

1. An on-demand system to produce diatomic molecular hydrogen and oxygen (HHO) gases for use as an additive in internal combustion engines, said system comprising a fluid reservoir, a fluid pump, a heat exchanger, a fluid electrolyzer, a filter assembly, and a combined electronic control system (ECS) and combustion control module (CCM),
said reservoir including overfilling prevention safeguards, fluid flush and fill systems, a plurality of sensors to determine fluid fill level, fluid temperature and internal pressure, a fluid return tube, and means for rigidly attaching said reservoir and a system cabinet to a vehicle frame that also supports an internal combustion engine;
said fluid pump being configured to deliver fluid throughout the on-demand system;
said heat exchanger configured to adjust the temperature of a fluid that will be pumped into said fluid electrolyzer;
said electrolyzer comprising a plurality of compartments, each said compartment being further divided into a plurality of electrolysis chambers that are situated in a. substantially vertical orientation, with top and bottom manifolds configured to optimize even fluid flow over a plurality of cathode and anode plates in the electrolysis chambers;
said filter assembly being configured in an upright orientation such that HHO gases are separated from electrolytic fluid vapor and byproducts, with the vapor and byproducts being drained back into said reservoir via a gravity feed and the HHO gases being supplied into the air stream that is integral to the operation of an internal combustion engine; and
said combined ECS and CCM being designed to communicate with each other and with a computerized engine control module (ECM) that has been designed and integrated into the internal combustion engine by its manufacturer via control area network technology in order to monitor the overall system and to control said overall system's operations.

2. The on-demand system described in claim 1, where said fluid reservoir includes an integrated flush and fill system that includes means to prevent HHO gas leakage from said reservoir.

3. The on-demand system described in claim 1, including a fluid return tube that originates at said electrolyzer and that terminates in said reservoir, said fluid return tube having a configuration that allows reintroduction of HHO gas along with electrolyte fluid back into said reservoir.

4. The on-demand system described in claim 1, wherein said reservoir is rigidly attached to a cabinet that contains the system itself, and said reservoir and cabinet are rigidly attached to a vehicle frame.

5. The on-demand system described in claim 1, wherein said heat exchanger is configured to allow said system to operate in a broad range of ambient temperatures.

6. The on-demand system described in claim 1, wherein the components of said system are manufactured from materials that are resistant to corrosion and electrical degeneration.

7. The on-demand system described in claim 1, wherein said electrolyzer includes four separate compartments.

8. The on-demand system described in claim 1, wherein each of the plurality of compartments in said electrolyzer includes six chambers.

9. The on-demand system described in claim 1, configured to pump at least one gallon of electrolyte fluid per minute into said electrolyzer, with said fluid being evenly distributed among said plurality of electrolyzer compartments.

10. The on-demand system described in claim 1, wherein the HHO gases and any by-products produced by the said electrolyzer are supplied into the bottom of said filter, and said filter separates said gases from said byproducts such that the gases are supplied into the air intake stream of an engine and said by-products are drained back into said reservoir.

11. The on-demand system described in claim 1, wherein said ECS and CCM communicate with a computerized ECM that is supplied by the manufacturer of an internal combustion engine in a handshake manner.

12. The on-demand system described in claim 1, wherein said ECS and CCM include safety mechanisms that cease operation of said system when an engine is not in a combustion state.

13. A method of generating HHO gases that may be supplied into the air supply stream of an internal combustion engine, said method comprising
storing a quantity of electrolyte fluid in a reservoir;
pumping said electrolyte fluid into a heat exchanger to adjust the temperature of said fluid;
electrolyzing said fluid in a multi-sectioned, multi-chambered electrolyzer;
separating byproducts and excess electrolyte fluid from said HHO gases via a filtration process and returning said byproducts and excess fluid to said reservoir; and
collecting filtered HHO gases that are produced in said electrolyzer and supplying said gases into the air supply stream of an internal combustion engine; and

14. The method described in claim 13, further including controlling said electrolysis process via ECS and CCM systems.

15. The method described in claim 13, wherein said method improves the fuel efficiency of a vehicle.

16. The method described in claim 13, wherein said method increases the power output of an internal combustion engine.

17. The method described in claim 13, wherein said method maintains environmental emission standards for vehicle emissions.
